(19) United States
(12) Patent Application Publication
(10) Pub. No.: US 2009/0215346 A1
(43) Pub. Date: Aug. 27, 2009

(54) Method for Fabricating Micro Pixel Liquid Crystal Display

(76) Inventors: Han-sik Kim, Seoul (KR); Ho-Jung An, Gyeonggi-do (KR)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 12/088,515

(22) PCT Filed: Dec. 2, 2005
(86) PCT No.: PCT/KR05/04108

§ 371 Date: Aug. 13, 2008

(51) Int. Cl. H01J 9/42; H01J 9/24; H01J 9/26; H01J 9/395

(52) U.S. Cl. 445/3; 445/24; 445/25; 445/57

(57) ABSTRACT

Methods of fabricating MPLCD are disclosed. A method of fabricating MPLCD comprising: depositing transparent electrode layers on top and bottom substrates, forming photoresist patterns by using an ordinary photolithography process, forming patterns on the electrode layers by using the photoresist patterns as a mask, assembling the substrates to form a semi-finished LCD, cutting the semi-finished LCD into individual cells, injecting an MP (Micro Pixel) mixture into each of the cells, wherein the MP mixture includes curable polymers and liquid crystals, curing the polymer in the MP mixture, to thereby form micro pixels within each cell, and attaching a polarizer on each side of the cell to thereby form the MPLCD.

### BACKGROUND OF THE INVENTION

1. Field of the Invention

The present invention relates to a liquid crystal display device; and, more particularly, to a method for fabricating a micro pixel liquid crystal display.

2. Background of the Related Art

E-papers are currently being developed with a view to replacing conventional pulp papers. In order, however, for the e-paper to replace the conventional pulp paper, there are some technical issues that must be overcome. To mention a few, like the conventional pulp paper, as well as being flexible, it must have low power consumption and fast response time.

One of the most promising e-paper technologies currently available is so called the electrophoretic display technology. There is, shown in FIG. 1, an electrophoretic display incorporating therein micro-capsule technology. Each of the micro-capsules has a diameter ranging between 30 and 70 micrometer and contains positively charged white and negatively charged black pigment chips. Images are displayed on the electrophoretic display by selectively applying an electric field between top and bottom transparent electrodes. When an electric filed is applied, the positively and negatively charged black and white pigment chips in the micro-capsule move toward the corresponding electrodes. By this principle, a contrast is formed on the display, allowing a word or an image to be displayed through the top transparent electrode. However, it takes a relatively high driving voltage, between 30-70V, and has response is relatively slow, due to the relatively big size of the micro-capsules and the need for the pigments to move thereacross. In addition, it cannot display gray scale.

There is, shown in FIG. 2, another example of an electrophoretic display incorporating therein micro-cup technology, instead of micro-capsule. Each of the micro-cups has a width ranging between 60 and 180 micrometer, a thickness ranging between 5 and 30 micrometer, and a height ranging between 15 and 40 micrometer, respectively. The micro-cup is formed on a substrate by an embossing treatment, and a mixture of one-type charged particles and a pigment are injected thereinto. To prevent a leakage of the particles and pigment from the micro-cup, the micro-cup is sealed with a sealing layer. An upper electrode is adhered to the sealing layer through an adhesive layer. When an electric field is selectively applied, words and images are displayed on the display under the same principle as the micro-capsule. However, this type of display saddled with the same deficiencies as the micro-capsule type, such as high driving voltage and slow response time. Although the driving voltage of this type of display ranging between 10 and 55V is lower than that of the micro-capsule type due to the relatively smaller size of the micro-cups compared to micro-capsules, it is still relatively high to be used in a portable device, and as in the micro-capsule type, since the particles must be physically moved, the response time thereof is still too slow.

There is, disclosed in Korean Patent application No. 10-2005-0043425, an MPLCD (micro pixel liquid crystal display) developed to overcome the deficiencies described above.

### SUMMARY OF THE INVENTION

The present invention is related to a method for fabricating the MPLCD.

Additional objectives and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objectives and other advantages and in accordance with the purpose of the invention, as embodied and broadly described herein, a method for fabricating MPLCD comprises: depositing transparent electrode layers on top and bottom substrates, forming photoresist patterns by using an ordinary photolithography process, forming patterns on the electrode layers by using the photoresist patterns as a mask, assembling the substrates to form a semi-finished LCD, cutting the semi-finished LCD into individual cells, injecting an MP (Micro Pixel) mixture into each of the cells, wherein the MP mixture includes curable polymers and liquid crystals, curing the polymer in the MP mixture, to thereby form micro pixels within each cell, and attaching a polarizer on each side of the cell to thereby form the MPLCD.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a schematic drawing of micro-capsule display;

FIG. 2 represents a schematic drawing of micro-cup display;

FIG. 3 shows a schematic flow chart for fabricating an MPLCD;

FIG. 4 depicts a schematic flow chart for curing UV curable polymers during the fabrication of MPLCD;

FIG. 5 presents a schematic flow chart for curing heat curable polymers during the fabrication of MPLCD;

FIG. 6 demonstrates a schematic side view of the MPLCD; and

FIG. 7 shows a top view of the MPLCD.

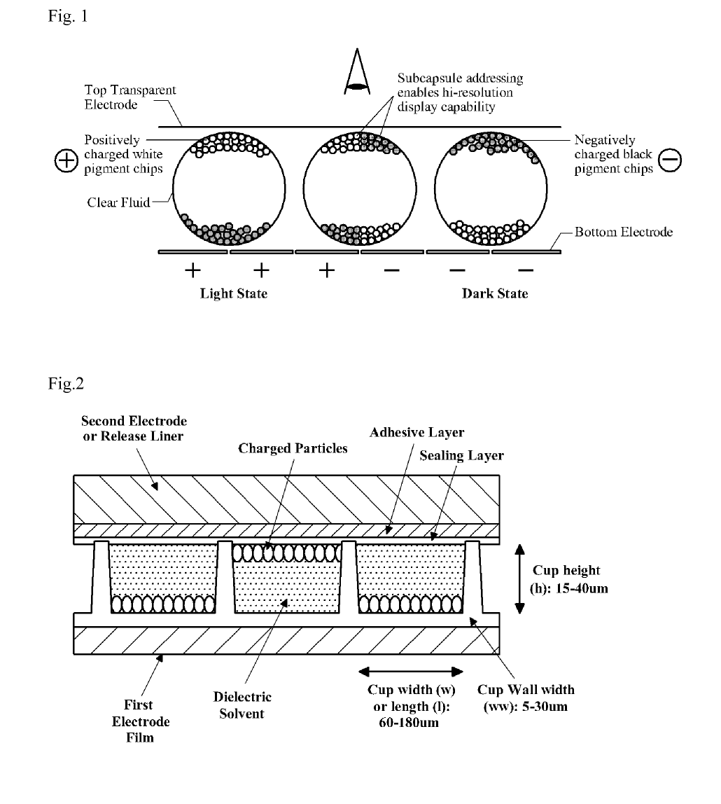

### DETAILED DESCRIPTION OF THE PREFERRED EMBODIMENT

Reference will now be made in detail to the preferred embodiments of the present invention, examples of which are illustrated in the accompanying drawings.

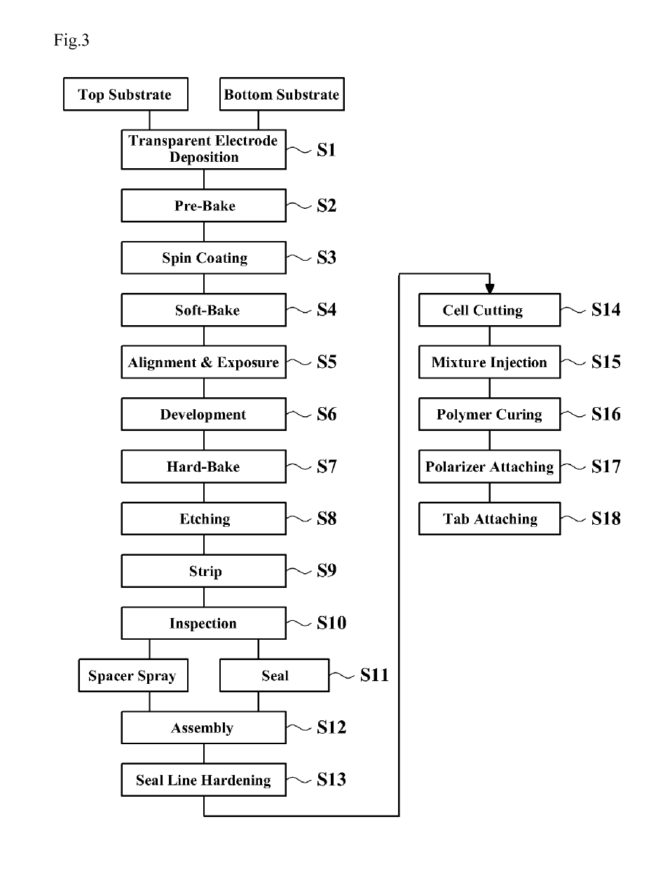

Referring to FIG. 3, a MPLCD panel fabrication process of the present invention is similar to that of conventional PM (Passive Matrix) plastic film LCD process except for an additional need to perform a polymer curing process after a MP mixture has been injected into each cell, instead the LC as in the conventional LCD process.

Referring to S1 process in FIG. 3, transparent electrodes are deposited on top and bottom substrates, usually plastic films, by sputtering

Referring to S2 process in FIG. 3, the two substrates are then pre-baked to prevent them from being deformed during subsequent processes, made necessary as a result of the inherent weakness of the plastic films to heat.

Referring to S3 through S9 processes in FIG. 3, the transparent electrodes are patterned using a conventional patterning process, comprising of spin coating S3, soft-bake S4, alignment and exposure S5, develop S6, hard-bake S7, etching S8, strip S9 and inspection S10.

During the spin coating process S3, photo-resist is coated on the substrates by spinning the substrate and then, soft-bake process S4 is performed to dry out the excessive solvent in the photo-resist.

To form patterns on the photo-resist coated on the substrates, alignment and exposure process S5 are performed. During the alignment and exposure process S5, the substrates are placed on an aligner and exposed to ultra violet light illuminated through a mask.

Referring to S6 process, the exposed areas of photo-resist on the substrates are removed using a developer, and unexposed areas are left on the substrates. Latter, in S8 process, the unexposed areas left after the develop process are used as an etching mask during a transparent electrode etching process.

Then, a hard-bake process S7 of the substrate is performed to harden the photo-resist left on the substrate after the develop process.

Referring to S8 process, by using the photo-resist as the etching mask, the etching process is performed to make same patterns made on the photo-resist on the transparent electrodes. These patterned electrodes are used to set up the voltage across the cell necessary for the orientation transition. After etching process, the photo-resist is removed by the strip process S9. Then, the patterned electrodes are inspected (S10).

Next, spacers and sealants are applied on the substrates (S11). Among the two substrates, one substrate is coated with a layer of polymer spacer beads or column spacers. These spacers maintain a uniform gap, also known as the cell gap, between the substrates. The spacers are applied on whole area of the substrate or on a selected area. Sealants are then applied on the other substrate. The sealant can be a UV cured polymer or a heat cured polymer. A portion of the substrate is left without the sealants for a subsequent MP (Micro Pixel) mixture injection therethrough.

Now, the two substrates are assembled together (S12) and the sealed lines are hardened by exposing them to UV light or heat (S13) depending on the sealants used therein to thereby form a semi-finished LCD cell (S12 and S13) which is then cut into individual cells (S14).

Instead of injecting liquid crystal into each cell as in the conventional process, an MP mixture, which basically is a mixture of a liquid crystal and a curable polymer, is injected into each cell. In the preparation of the MP mixture, viscosity and concentration of the polymer are the two most important factors. For facilitating the mixing process, the polymer viscosity should be lower or similar to that of the liquid crystal. In the present invention, viscosity of the polymer is about 5-1000 cps and that of the liquid crystal is about 5-1000 cps. The concentration of polymer in the mixture affects the thickness of walls formed in the individual cell. If the concentration of the polymer is low, the walls will be very thin. Making the resultant MPLCD will be very susceptible to a physical external force applied thereto such as bending and pressure. If too high, the resultant MPLCD will become opaque and will require extremely high driving voltage. In the mixing process, the MP mixture can be mixed with or without heating depending on its viscosity. After mixing process, the liquid crystal and polymer mixture is injected into the individual cell under a vacuum (S15).

Once the cell has been filled out with the mixture, the individual cell is sealed and a polymer curing process S16 is performed to form alignment layers and micro pixels inside of the cell.

After the polymer curing process S16, polarizers (the transparent, reflective, or translucent layers with lines) are applied to an exposed cell surface (S17). In a TN display, the alignment layers are positioned with their rubbing directions perpendicular to each other and the polarizers are applied to match the orientation of the alignment layers. In an STN display the alignment layers are placed with their rubbing directions at a variety of angles to one another to set up a twist from 180 to 270 degrees and the polarizers are not applied parallel to the alignment layers. Then, TABs which are bonding electrode to provide electricity into the panel are attached on the side of the panel (S18).

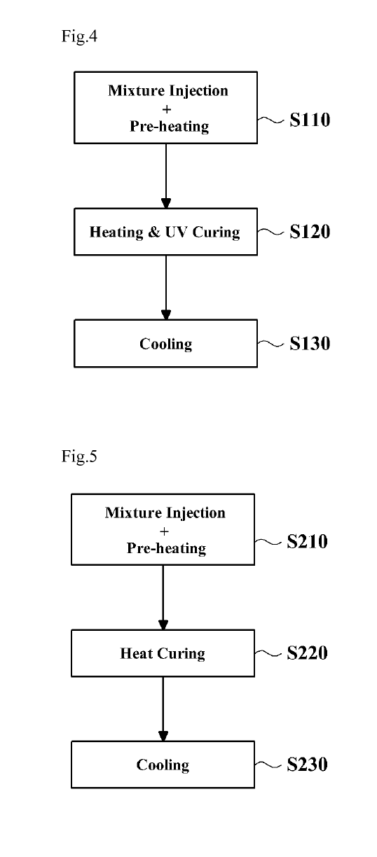

Referring to FIG. 4, a UV polymer curing process is described when the MP mixture includes a UV curable polymer. The MP mixture is injected into the cell (S110). The mixture can be injected with or without pre-heating process. If the viscosity of the MP mixture is too high for it to flow into the cell, a pre-heating of the mixture can facilitate a smooth injection thereof into the cell. In case of the MP mixture having an appropriate viscosity, the pre-heating is not required. However, pre-heating is still helpful for a smooth injection of the MP mixture for all cases, the pre-heating temperature ranging between 25 and 75° C. After the MP mixture injection (S110), the curable polymer in the MP mixture is cured with UV light at an intensity ranging between 100 mJ and 100 J (S120). For more efficient curing, the cell is heated to a temperature ranging between 30 and 80° C. while UV light is illuminated onto the cells. The UV light should illuminate the entire surface of the LCD cell. In addition, for a uniform forming of micro pixels within the cells, the UV light source should be placed on opposite sides of the cell. Further, the number of UV light sources should not be restricted to one, i.e., there can be two or more on each side of the cell depending on the size of the cell. After the formation of the micro pixels within the cell, then the cell is cooled down to room temperature (S130).

Referring to FIG. 5, a polymer curing process involving a heat curing polymer in the MP mixture is described. Like the MP mixture injection process described in the UV curing process, the MP mixture can be injected into the individual cell with or without the pre-heating process (S210). As opposed to the UV curing described above, however, the pre-heating temperature, in this case, is dependent upon the curing temperature of the polymer and cannot exceed the curing temperature of the polymer, the pre-heat temperature ranging is between 25-120° C. After the MP mixture has been injected into the cell (S210), the polymer is cured at a temperature ranging between 40-180° C., depending on the curing temperature of the polymer (S220). Once the polymer has been completely cured, the cell is cooled to room temperature (S230). During the polymer curing process, i.e., UV or heat, the curing begins by first forming layers on the electrodes, followed by polymer walls forming perpendicular thereto. The layers formed on the electrodes act as alignment layers, and the liquid crystals in the MP mixture get isolated from each other through the walls.

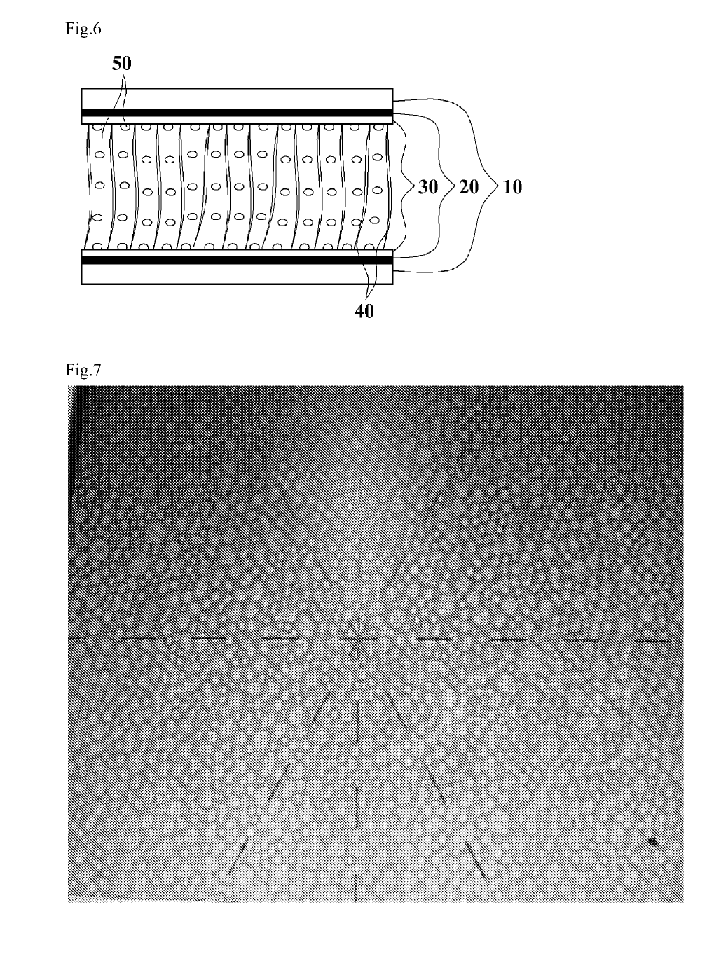

Referring to FIG. 6, there is shown a schematic cross-sectional view of a MPLCD of the present invention. The transparent electrode layers (20) are formed on the substrates (10) and the alignment layers (30) are formed on the electrode layers (20). The polymer walls (40) are formed in the cell between the alignment layers and the direction of the walls is perpendicular to the alignment layer. Then, the liquid crystals (50) are isolated between the walls (40). According to the present invention, the cell gap is about 0.5-10 micrometers.

Referring to FIG. 7, a top view of the present invention is shown. Micro pixels have almost circular form and diameters of the pixels range between 0.5 and 30 micrometers.

According to the present invention, a driving voltage of the MPLCD is about 1-20V.

In addition to PM LCD, the method described herein can be used in fabricating of AM LCDs, which will just require additional steps for fabricating a TFT (Thin Film Transistor) array.

The foregoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. A method of fabricating MPLCD comprising:
depositing transparent electrode layers on top and bottom substrates;
forming photoresist patterns by using an ordinary photolithography process;
forming patterns on the electrode layers by using the photoresist patterns as a mask;
assembling the substrates to form a semi-finished LCD;
cutting the semi-finished LCD into individual cells;
injecting an MP (Micro Pixel) mixture into each of the cells, wherein the MP mixture includes curable polymers and liquid crystals;
curing the polymer in the MP mixture, to thereby form micro pixels within each cell; and attaching a polarizer on each side of the cell to thereby form the MPLCD.

2. The method of claim 1, wherein the substrates are flexible substrates such as plastic films.

3. The method of clam 1, further comprising:
pre-baking the substrates after deposition of the transparent electrode layers.

4. The method of claim 1, wherein the ordinary photolithography process comprising:
spin-coating a photoresist on the electrode layers;
soft-baking the photoresist;
placing the substrates on an aligner;
exposing the photoresist to an UV light;
developing the photoresist; and
hard-baking the photoresist;

5. The method of claim 1, further comprising:
inspecting the patterns of the electrodes after forming the pattern formation.

6. The method of claim 1, the assembly of the substrates comprising:
spraying a spacer on one of the substrates and applying a sealant on the other substrate to form seal lines;
combining the substrates; and
hardening the seal lines.

7. The method of claim 6, wherein the spacer is a ball or a column spacer.

8. The method of claim 6, wherein the sealant is an UV curable polymer or a heat curable polymer.

9. The method of claim 6, wherein the seal line is hardened using UV or heat.

10. The method of claim 1, wherein a viscosity of the curable polymer in the MP mixture is 5-1000 cps.

11. The method of claim 1, wherein a viscosity of the liquid crystal in the MP mixture is 5-1000 cps.

12. The method of claim 1, wherein the polymer in the MP mixture is either UV curable polymer or heat curable polymer.

13. A method of curing the polymer in the MP mixture comprising:
injecting the MP mixture into the cell;
exposing the cell to at least a UV source; and
cooling the cell.

14. The method of claim 13, further comprising:
pre-heating the cell while injecting the mixture into the cells.

15. The method of claim 14, wherein the pre-heating temperature is 23-50° C.

16. The method of claim 13, further comprising:
heating the cell while the polymer is cured.

17. The method of claim 16, wherein the heating temperature is 30-70° C.

18. A method of curing polymer of the MP mixture in the cell comprising:
injecting the MP mixture into the cell;
exposing the cell to at least a heat source; and
cooling the cell.

19. The method of claim 18, further comprising:
pre-heating the cell while injecting the mixture into the cell.

20. The method of claim 19, wherein a pre-heating temperature is 23-120° C.

21. The method of claim 18, wherein a heat curing temperature is 40-180° C.
